(19) United States
(12) Patent Application Publication
(10) Pub. No.: US 2012/0159981 A1
(43) Pub. Date: Jun. 28, 2012

(54) DRAIN PAN FOR USE IN A HEATING VENTILATION AIR CONDITIONING SYSTEM

(76) Inventors: Christopher D. Beck, Grenada, MS (US); Mike Denley, Calhoun, MS (US)

(21) Appl. No.: 12/975,527

(22) Filed: Dec. 22, 2010

(51) Int. Cl. F25D 21/14; B29C 67/00; B65D 1/34

(52) U.S. Cl. 62/291; 220/571; 264/239

(57) ABSTRACT

The present disclosure is directed to a drain pan that comprises a base pan section having a central air flow opening located therethough and an anchoring rim section located along the air flow opening. A condensate deflector is located at the air flow opening and at an end of the at least one anchoring rim section. The condensate deflector and anchoring rim section form a corner, wherein an upper portion of the corner extends along a same side of the opening as the anchoring rim section. The drain pan further comprises a condensate channel located between an outer perimeter of the base pan section and the condensate deflector. The condensate channel extends from one side of the base pan section to an opposing side of the base pan section. A method of fabricating the drain pan is also provided.

### TECHNICAL FIELD

This application is directed, in general, to a drain pan for use in a heating ventilation and air conditioning (HVAC) system.

### BACKGROUND

HVAC plenums and their concomitant drain pans are well known and have been used for decades in the HVAC industry. In some applications, the direction of the output airflow is in a vertical, downward direction. This airflow direction can often lead to problems, such as water condensate leakage, that are not typically associated with horizontal units. Such leakage, of course, is highly undesirable because it can lead to water damage in the structure in which the HVAC unit is placed.

### SUMMARY

One aspect provides a drain pan, comprising a base pan section having a central air flow opening located therethough and at least one anchoring rim section located along the air flow opening. At least one condensate deflector is located at the air flow opening and at an end of the anchoring rim section. The condensate deflector is oriented at an angle with respect to the base pan section such that the condensate deflector partially extends into the air flow opening. The condensate deflector and anchoring rim section form a corner, wherein an upper portion of the corner extends along a same side of the opening as the anchoring rim section. The drain pan further comprises at least one condensate channel located between an outer perimeter of the base pan section and the condensate deflector.

In another embodiment an integrally formed drain pan unit for a heating ventilation air conditioning (HVAC) system is provided. In this embodiment, the drain pan comprises a base pan section having a central air flow opening located therethough. The central air flow opening is defined by opposing first and second anchoring rim sections and opposing first and second condensate deflectors integrally formed with the base pan section. The first and second anchoring rim sections and condensate deflectors form corners, wherein an upper portion of each of the corners extends along a same side of the opening as the first and second anchoring rim sections, respectively. The first and scone opposing condensate deflectors are oriented at an angle with respect to the base pan section such that the opposing condensate deflectors partially extend into the air flow opening. Condensate channels integrally formed with the base pan section are located between an outer perimeter of the base pan section and each of the opposing condensate deflectors.

In another embodiment, a method of manufacturing a drain pan for a heating ventilation air conditioning (HVAC) system is disclosed. In this embodiment, the method comprises forming a base pan section having a central air flow opening located therethough from a composite material, wherein the central air flow opening is defined by: opposing first and second anchoring rim sections and opposing first and second condensate deflectors integrally formed with the base pan section. The first and second anchoring rim sections and first and second condensate deflectors form corners, wherein an upper portion of each of the corners extends along a same side of the opening as the first and second anchoring rim sections, respectively. The opposing first and second condensate deflectors are oriented at an angle with respect to the base pan section such that the opposing condensate deflectors partially extend into the air flow opening. The method further comprises forming condensate channels in the base pan section that are located between an outer perimeter of the base pan section and the opposing first and second condensate deflectors, respectively.

### BRIEF DESCRIPTION

Reference is now made to the following descriptions taken in conjunction with the accompanying drawings, in which:

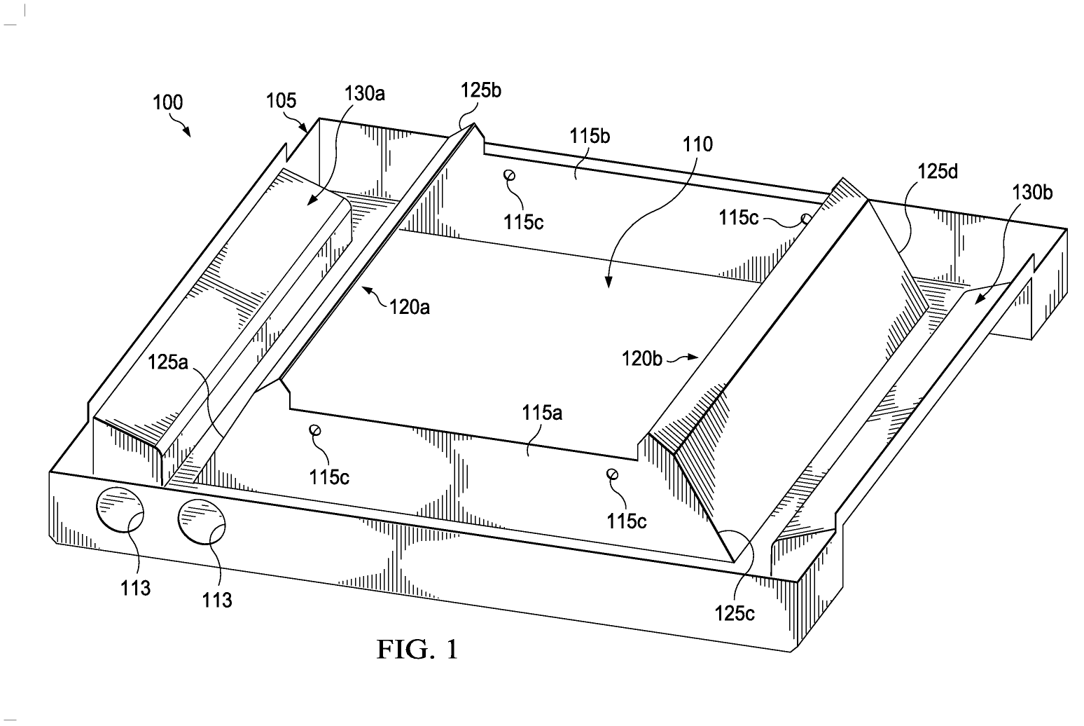

FIG. 1 illustrates one embodiment of a drain pan as provided herein;

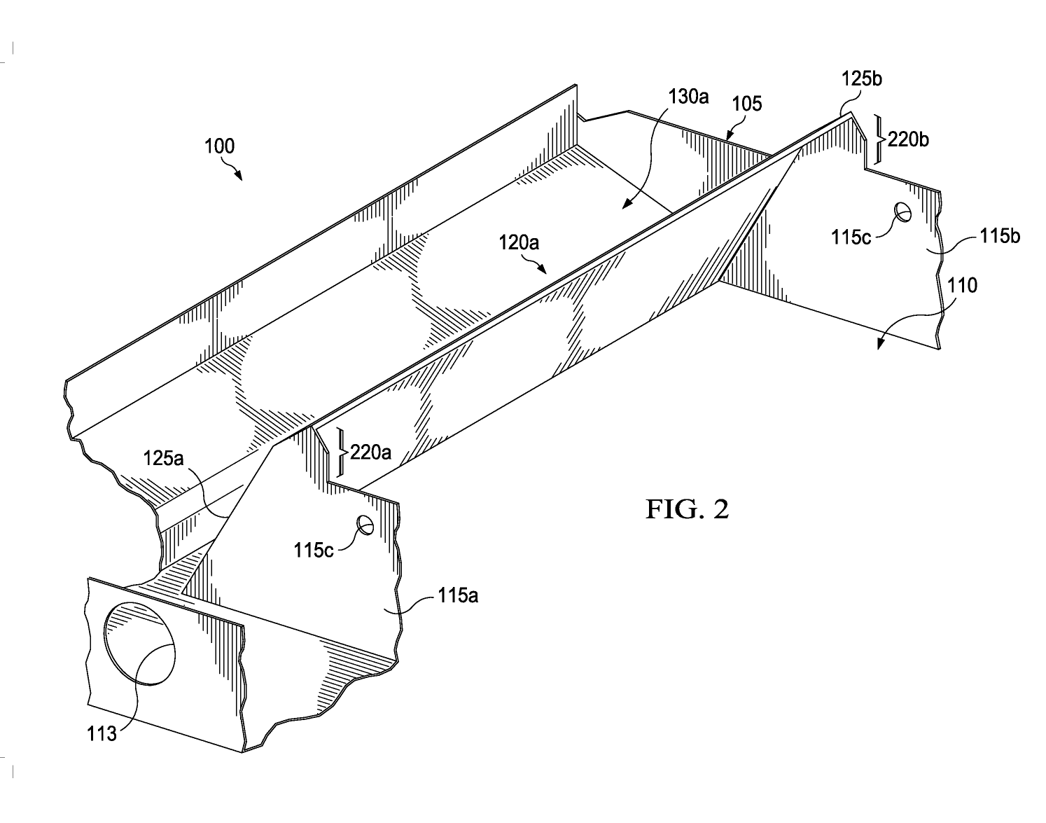

FIG. 2 illustrates a partial, enlarged view of the embodiment of FIG. 1;

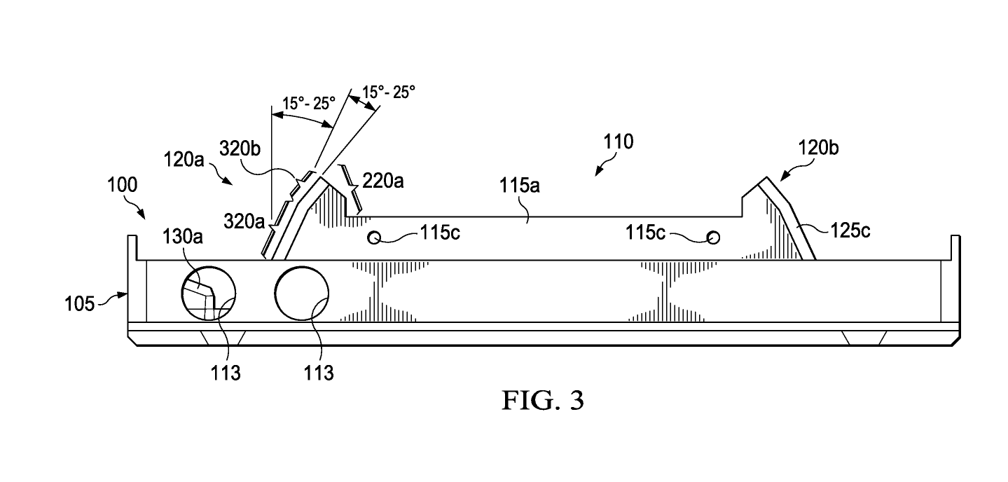

FIG. 3 illustrates a side view of the embodiment of FIG. 1; and

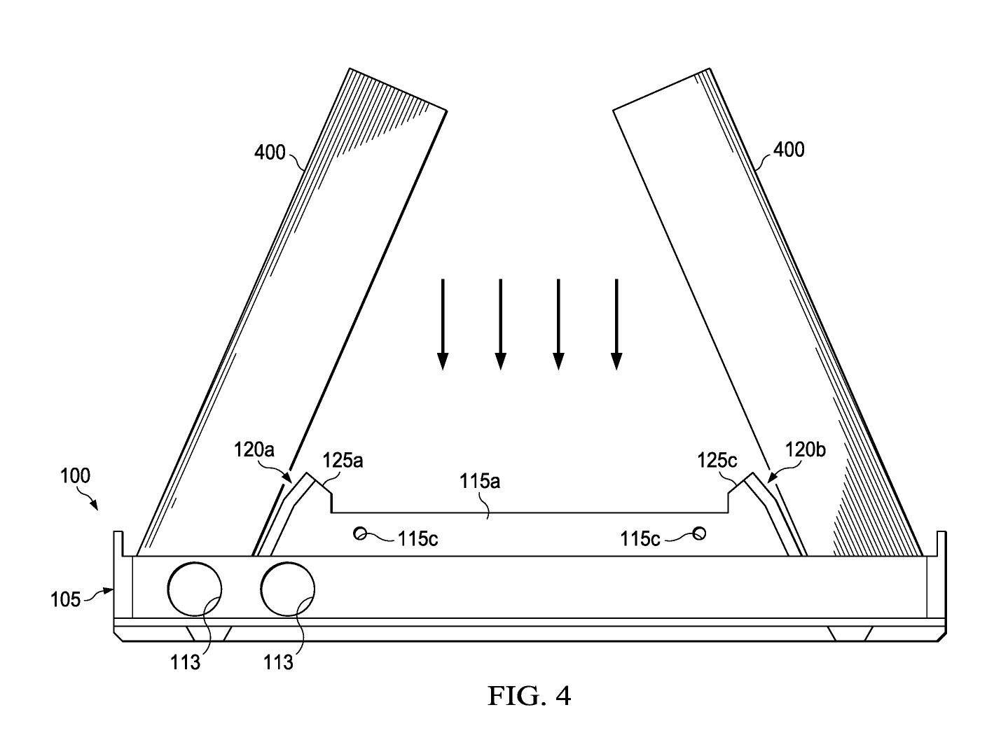

FIG. 4 illustrates an embodiment of the drain pan as provided herein and having condensing coils positioned in opposing condensate channels.

### DETAILED DESCRIPTION

Manufactured homes or modular homes have been a part of the housing industry for decades. In times past, these residence structures were often cooled by individual window units. However, as HVAC technology has improved, central HVAC cooling units are now extensively used in these mobile or residential units. Given the limitations of these structures, the central HVACE cooling units are often configured for a downward directed air flow. As a result, condensate that is formed on the condensing coils is often pulled by the air flow into the opening, which can cause water damage to the support structure and ceiling. This, of course, is undesirable, and the HVAC manufacturing industry has tried various solutions to prevent this leakage from occurring. Though condensate deflectors have previously been employed in these units, these designs have failed to completely stop the leakage. The present disclosure, however, addresses this concern by providing embodiments of an improved drain pan as disclosed herein. The results obtained from this improved drain pan were quite unexpected, as many different configurations were attempted before arriving at the embodiments disclosed herein.

FIG. 1 illustrates one embodiment of a drain pan 100 as provided herein. In this particular embodiment, the drain pan 100 comprises a base pan section 105 that has a central air flow opening 110 and drain openings 113 located therethough. The base pan section 105 provides the base for the drain pan 100 in which condensate is collected from condensing coils (not shown) and also serves to support those coils when they are positioned in the drain pan 100. The drain pan 100 is held or secured in place by one or more anchoring rim sections 115a and 115b that are located along the sides of the air flow opening 110. As seen in this embodiment, the anchoring rim sections 115a, 115b have small openings 115c located through them, through which a screw or bolt might be received to hold or secure the drain pan 100 to a structural frame of the space that is intended to be cooled. Though two anchoring rim sections 115a, 115b are shown, it should be understood that in certain embodiments, the drain pan 100 may have only one such anchoring rim section or may have more than the two that are shown.

Located at the air flowing opening 110 and at opposing ends each of the anchoring rim sections 115a, 115b are opposing condensate deflectors 120a, 120b. The anchoring rim sections 115a, 115b and condensate deflectors 120a, 120b meet to form corners 125a, 125b, 125c, and 125d, respectively. Though two condensate deflectors 120a, 120b are shown, it should be understood that in certain embodiments, the drain pan 100 may have one or more than the two that are shown.

The drain pan 100 further comprises condensate channels 130a, 130b located between an outer perimeter of the base pan section 100 and the condensate deflectors 120a, 120b. The condensate channels 130a, 130b extend in a lateral direction parallel with the condensate deflectors 120a, 120b from one side of the base pan section 105 toward the other side and ends adjacent the opposing side of the base pan section 105 in which the drain openings 113 are located, as shown in the illustrated embodiment. The condensate channels 130a, 130b may be formed to tilt toward the condensate deflectors 120a, 120b, respectively. These respective tilts direct the condensate to the base of the condensate channels 130a, 130b, which then directs the condensate to the drain openings 113. However, in another aspect, the condensate channels 130a, 130b may be titled downwardly toward the drain openings 113. As such, the end of the condensate channels 130a, 130b located most distal from the drain openings 113 is raised with respect to the end closest the drain openings 113. This front to back tilt provides additional drainage inertia toward the drain openings 113. In certain embodiments, the two above-described tilts of the condensate channels 130a, 130b may be present together or signally.

FIG. 1 shows the drain pan 100 and its various components formed as a single integral unit. In such embodiments, the drain pain 100 may be formed from a molded or machine shaped composite material, such as resin composites, or high thermal/high impact plastic materials. Those skilled in L the art of molding such materials understand which materials are best to meet the strength and overall design requirements and how to mold the materials to form the drain pan 100. However, in other embodiments, the drain pan 100 may be comprised of a number of assembled parts. For example, the condensate deflectors and the condensate drain channels may be added to the base drain pan section 105 as a single stamped or formed piece of metal that is conventionally secured to the base drain pan section 105.

FIG. 2 illustrates a partial, enlarged view of the drain pan 100 shown in the embodiment of FIG. 1. This view focuses on upper portions 220a, 220b of corners 125a, 125b, respectively, which extend along a same side of the opening 110 as the anchoring rim sections 115a, 115b. The upper portions 220a, 220b may be formed in different ways. For example, in an embodiment where the drain pan 100 is an integrally molded or shaped single unit, the upper corners 220a, 220b would simply be molded or shaped into the unit as seen in FIG. 2. In other embodiments where the condensate deflector 120a is a separate component from that of the base pan section 105, the material comprising the condensate deflector 120a may be stamped or individually shaped to wrap around the corner of the opening 105. In yet another embodiment, the condensate deflector 120a and the anchoring rim sections 115a, 115b, may be machined and mitered in such a way as to form the upper portions 220a, 220b of the corners 125a, 125b with an appropriate sealant added thereto. As mentioned above, the significant amount of reduction in leakage that was achieved by employing the upper portions 220a, 220b, which wrap around the corners 125a, 125b were unexpected in view of other designs that were attempted.

FIG. 3 illustrates a side view of an embodiment of the drain pan 100 in which the condensate deflectors 120a, 120b are oriented at an angle with respect to the base pan section 105 such that the condensate deflectors 120a, 120b partially extend into the air flow opening 110. In different embodiments, the degree of the angle may range from about 15° to about 25°, with about 15° providing good results. In the illustrated embodiment, the deflector 120a is comprised of a first section 320a and a second section 320b, both of which are angled, as generally indicated in FIG. 3. Further, the second section 320b may be considered to be angled with respect to the first section 320a, as also shown in FIG. 3. The degree of angle in each section may be different and can be within the above stated range. However, in one embodiment, the angles are equal to one another. That is, the angle of the first section 320a with respect to the base pan section 105 is the same as the angle of the second section 320b with respect to the first section 320a, as generally shown in FIG. 3. In one particular embodiment that provided good results, each of these angles was about 15° (±2°. When these sections 320a, 320b were combined with the wrapped corners, the amount of leakage from the drain pan was significantly if not completely stopped altogether. It should be understood that each of the condensate deflectors present in the drain pan may be configured in this manner.

FIG. 4 illustrates the drain pan 100 of FIG. 1 with condensing or refrigeration coils 400 positioned therein. The downward air flow is indicated by the arrows. As air flows downward. Condensate removal is enhanced by the drain pan in the down flow position with the combination of many assets of the drain pan design. The condensate is pushed by the downward airflow and gravity along the section 400. The downward pressure of the airflow is pushed on the inner wall of section 120a and 120b and in many cases pushed toward the front and rear corners of the drain pan, where the pressure is at the highest in the embodiment. The wrap around corners seal the drain pan against the coil/sheet metal surface that cover the united walls 115a, 120a, 120b, 125a, 125c seen in FIG. 4. This creates a wrap around feature that prohibits condensate from being pushed over the inner wall of the drain pan. Without this embodiment the condensate is pushed into the center opening of the drain pan and causes damage to the homeowners possessions. The drain pan is angled from the rear to the front, where the condensate collects in channels that are angled from the outer portion 105 of the drain pan to the inner walls 120a/120b. The condensate then moves from these area's toward the drain opening 113 and out to the owners sewer or drainage area of the home.

Several different configurations having deflectors ranging from 14 inches tall to 22 inches tall in a 3 row configuration showed no condensate blow-off in situations where the cubit feet/minute (CFM) ranged from about 449 CFM to 1210 CFM for the 14 inch configuration, 537 CFM to 1344 CFM for the 18 inch configuration and 605 CFM to 1471 CFM for the 22 inch configuration. Further, configurations having deflectors ranging from 18 inches tall to 22 inches tall in a 4 row configuration showed no condensate blow-off in situations where the CFM ranged from about 611 CFM to 1419 CFM for the 18 inch configuration and 534 CFM to 1552 for the 22 inch configuration.

Those skilled in the art to which this application relates will appreciate that other and further additions, deletions, substitutions and modifications may be made to the described embodiments.

What is claimed is:

1. A drain pan, comprising:
a base pan section having a central air flow opening located therethough and at least one anchoring rim section located along said air flow opening;
at least one condensate deflector located at said air flow opening and at an end of said at least one anchoring rim section, said at least one condensate deflector oriented at an angle with respect to said base pan section such that said at least one condensate deflector partially extends into said air flow opening, said at least one condensate deflector and anchoring rim section forming a corner, wherein an upper portion of said corner extends along a same side of said opening as said at least one anchoring rim section; and
at least one condensate channel located between an outer perimeter of said base pan section and said at least one condensate deflector and extending from one side of said base pan section to an opposing side of said base pan section.

2. The drain pan recited in claim 1, wherein said angle ranges from about 15° to about 25°.

3. The drain pan recited in claim 1, wherein said angle is a first angle and said at least one condensate deflector comprises a first section that is oriented at said first angle and a second section that is angled with respect to said first section at a second angle.

4. The drain pan in claim 3 wherein said first angle is equal to said second angle.

5. The drain pan recited in claim 4, wherein said first and second angles range from about 15° to about 25°.

6. The drain pan recited in claim 1, wherein said base drain pan, said at least one anchoring rim section, said at least one condensate deflector, and said at least one condensate channel are integrally formed of a composite material.

7. The drain pan recited in claim 1 wherein said base pan section includes drain holes formed therethrough and said at least one condensate channel being inclined toward said drain holes.

8. An integrally formed drain pan unit for a heating ventilation air conditioning (HVAC) system, comprising;
a base pan section having a central air flow opening located therethough, said central air flow opening defined by:
opposing first and second anchoring rim sections and opposing first and second condensate deflectors integrally formed with said base pan section, said first and second anchoring rim sections and condensate deflectors forming corners, wherein an upper portion of each of said corners extends along a same side of said opening as said first and second said anchoring rim sections, respectively;
said opposing first and second condensate deflectors oriented at an angle with respect to said base pan section such that said opposing first and second condensate deflectors partially extend into said air flow opening; and
condensate channels integrally formed with said base pan section and located between an outer perimeter of said base pan section and each of said opposing condensate deflectors.

9. The integral drain pan recited in claim 8, wherein said angle ranges from about 15° to about 25°.

10. The integral drain pan recited in claim 8, wherein said angle is a first angle and each of said opposing condensate deflector comprises a first section that is oriented at said angled and a second section that is angled with respect to said first section at a second angle.

11. The integral drain pan recited in claim 10, wherein said first angle is equal to said second angle.

12. The integral drain pan recited in claim 11, wherein said first and second angles range from about 15° to about 25°.

13. The integral drain pan recited in claim 8, wherein said integral drain pan comprises a molded composite material.

14. The integral drain pan recited in claim 8, wherein said base pan section includes drain holes formed there through and each of said condensate channels is inclined toward said drain holes.

15. The integral drain pan recited in claim 8 further including first and second condensing coils positioned in said condensate channels.

16. A method of manufacturing a drain pan for a heating ventilation air conditioning (HVAC) system, comprising:
forming a base pan section having a central air flow opening located therethough from a composite material, said central air flow opening defined by:
opposing first and second anchoring rim sections and opposing first and second condensate deflectors integrally formed with said base pan section, said first and second anchoring rim sections and condensate deflectors forming corners, wherein an upper portion of each of said corners extends along a same side of said opening as said first and second said anchoring rim sections, respectively;
said opposing first and second condensate deflectors each oriented at an angle with respect to said base pan section such that said opposing first and second condensate deflectors partially extend into said air flow opening; and
forming condensate channels in said base pan section and between an outer perimeter of said base pan section and said opposing first and second condensate deflectors.

17. The method recited in claim 16, wherein forming said base pan section includes integrally forming said anchoring rims, said condensate deflectors therewith, and said forming condensate channels comprises integrally forming said condensate channels with said base pan section.

18. The method recited in claim 16, wherein said angle is a first angle and each of said opposing condensate deflector comprises a first section that is oriented at said first angle and a second section that is angled with respect to said first section at a second angle.

19. The method recited in claim 18, wherein said first and second angles range from about 15° to about 25°.

20. The method recited in claim 16, wherein forming said base pan section includes forming drain holes therethrough and forming each of said condensate channels includes forming said condensate channels such that said condensate channels are inclined toward said drain holes.
